(19) United States
(12) Patent Application Publication
(10) Pub. No.: US 2026/0092682 A1
(43) Pub. Date: Apr. 2, 2026

(54) PRESSURE VESSEL UNIT

(71) Applicant: TOYOTA JIDOSHA KABUSHIKI KAISHA, Toyota-shi (JP)

(72) Inventor: Chiaki KATAOKA, Nagakute-shi (JP)

(73) Assignee: TOYOTA JIDOSHA KABUSHIKI KAISHA, Toyota-shi (JP)

(21) Appl. No.: 19/261,031

(22) Filed: Jul. 7, 2025

(30) Foreign Application Priority Data
Oct. 1, 2024 (JP) 2024-172127

(51) Int. Cl. F17C 13/04

(52) U.S. Cl. CPC F17C 13/04; F17C 2205/0308; F17C 2205/0311

(57) ABSTRACT

A pressure vessel unit includes a plurality of pressure vessels, first end plugs, second end plugs, a joining portion, and bolts. Each pressure vessel has both ends in the longitudinal direction that are open. Each first end plug is provided in a corresponding one of the pressure vessels, seals an opening on one end side in the longitudinal direction, and is provided with a fluid supply passage through which fluid is supplied to the pressure vessel. Each second end plug is provided in a corresponding one of the pressure vessels, seals an opening on the other end side in the longitudinal direction, and is provided with a fluid discharge passage through which the fluid is discharged from the pressure vessel. The joining portion connects the pressure vessels. Each bolt is fixed to the second end plug to be mountable and removable and closes the fluid discharge passage.

### CROSS-REFERENCE TO RELATED APPLICATION

This application claims priority to Japanese Patent Application No. 2024-172127 filed on Oct. 1, 2024. The disclosure of the above-identified application, including the specification, drawings, and claims, is incorporated by reference herein in its entirety.

### BACKGROUND

### 1. Technical Field

The present specification discloses a technology relating to a pressure vessel unit.

### 2. Description of Related Art

In Japanese Unexamined Patent Application Publication No. 2024-003069 (JP 2024-003069 A), a pressure vessel unit in which a plurality of pressure vessels (hydrogen tanks) is joined to each other is disclosed. For such a pressure vessel, a pressure-proof test of each pressure vessel is required by law. The pressure-proof test is performed by filling each pressure vessel with a test fluid in the state of the pressure vessel unit or is performed by filling each single pressure vessel (a pressure vessel before being unitized) with the test fluid. After the pressure-proof test, the test fluid is discharged from the pressure vessel, and the inside of the pressure vessel is dried.

### SUMMARY

As described above, it is necessary to perform a pressure-proof test in a process of manufacturing a pressure vessel unit. For example, when the pressure-proof test is performed in the state of the pressure vessel unit, there is a need to discharge the test fluid from the pressure vessels, remove a large number of parts in order to dry the inside of the pressure vessels, and assemble the pressure vessel unit again after the pressure-proof test. In a case in which the pressure-proof test is performed for each single pressure vessel, there is also a need to discharge the test fluid from the pressure vessel, remove a large number of parts in order to dry the inside of the pressure vessel, unitize the pressure vessels by assembling the pressure vessels, and then perform an airtight test in the state of the pressure vessel unit. As above, when the pressure vessel unit is manufactured, there is a need to perform the pressure-proof test, and hence a large amount of time is required. When the amount of time required for the pressure-proof test can be shortened, the manufacturing cost (amount of manufacturing time) of the pressure vessel unit can also be reduced. An object of the present specification is to provide a technology of reducing the manufacturing cost of a pressure vessel unit.

In a first aspect disclosed by the present specification, a pressure vessel unit may include a plurality of pressure vessels, first end plugs, second end plugs, a joining portion, and bolts. The pressure vessels each have both ends in the longitudinal direction that are open. The first end plugs are each provided in a corresponding one of the pressure vessels. The first end plugs are each configured to seal an opening on one end side in the longitudinal direction. The first end plugs are each provided with a fluid supply passage through which fluid is to be supplied to the pressure vessel. The second end plugs are each provided in a corresponding one of the pressure vessels. The second end plugs are each configured to seal an opening on the other end side in the longitudinal direction. The second end plugs are each provided with a fluid discharge passage through which the fluid is to be discharged from the pressure vessel. The joining portion is configured to connect the pressure vessels. The bolts are each fixed to a corresponding one of the second end plugs in a mountable and removable manner. The bolts are each configured to close the fluid discharge passage.

In the configuration described above, it is possible to discharge the test fluid from the pressure vessel and dry the inside of the pressure vessel by simply removing the bolt closing the fluid discharge passage after the pressure-proof test of the pressure vessel unit is performed. There is no need to mount and remove a large number of parts after the pressure-proof test. Therefore, it is possible to shorten the amount of time necessary from the pressure-proof test to the completion of the pressure vessel unit and reduce the manufacturing cost of the pressure vessel unit.

In a second aspect, the joining portion may have a fluid flow passage joined to all of the fluid supply passages, and a valve mounting hole for mounting a valve configured to perform supply control of the fluid to the fluid flow passages in the first aspect described above.

With the configuration described above, it is possible to fill all of the pressure vessels with the test fluid through the valve mounting hole at the time of the pressure-proof test. At the time of discharging the test fluid from the inside of the pressure vessels and drying the inside of the pressure vessels after the pressure-proof test, air simply needs to be introduced to all of the pressure vessels through the valve mounting hole. Therefore, it is possible to easily perform the pressure-proof test and the drying of the inside of the pressure-proof vessels thereafter.

In a third aspect, the joining portion may be configured to fix the first end plug to the one end side when the pressure vessel is connected in the first or second aspect described above.

With the configuration described above, the joining portion can have both of a function of joining the pressure vessels and a function of fixing the first end plugs to the pressure vessels. Therefore, parts only used for fixing the first end plugs to the pressure vessels can be omitted.

In a fourth aspect, an end cap for fixing the second end plug to the other end side may be fixed to the other end side of the pressure vessel in any of the first to third aspects described above.

With the configuration described above, it is possible to reliably seal the opening of the pressure vessel by the second end plug.

In a fifth aspect, an opening through which the bolt passes when the bolt is mounted or removed may be provided in the end cap in the fourth aspect described above.

With the configuration described above, it is possible to discharge the test fluid from the inside of the pressure vessel and dry the inside of the pressure vessel while maintaining a state in which the end cap is mounted on the pressure vessel after the pressure-proof test ends.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a pressure vessel unit;

FIG. 2 shows a main-part sectional view of a pressure vessel;

FIG. 3 shows a section taken along line III-III of FIG. 1;

FIG. 4 shows a view for describing a pressure-proof test; and

FIG. 5 shows a main-part sectional view of the pressure vessel when fluid is discharged from the pressure vessel.

### DETAILED DESCRIPTION OF EMBODIMENTS

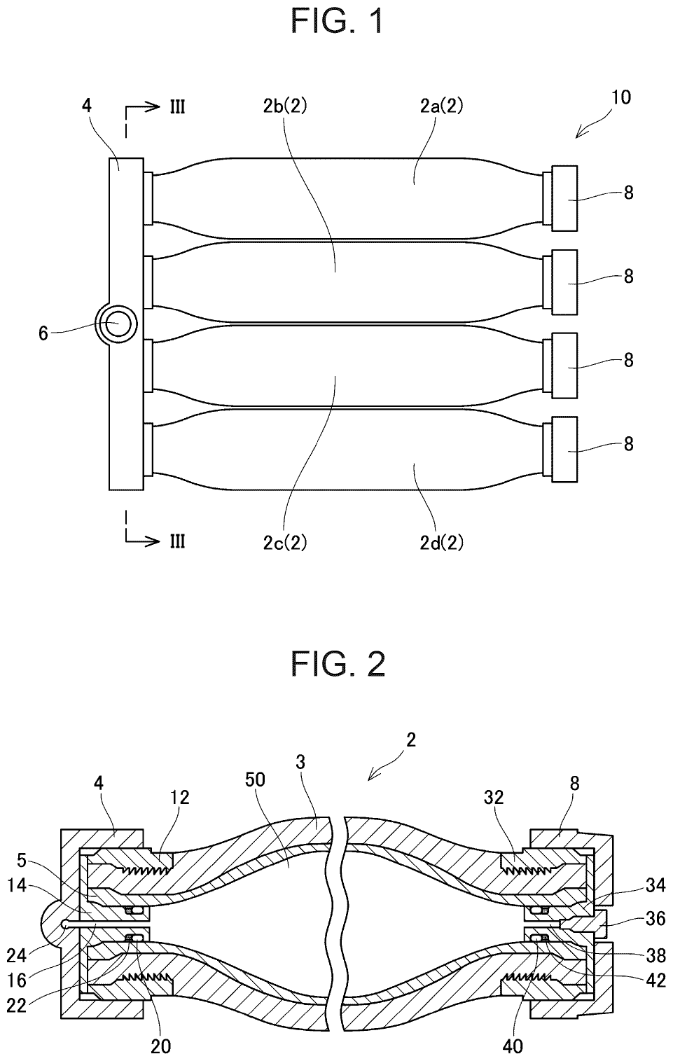

A pressure vessel unit 10 is described with reference to FIG. 1 to FIG. 3. The pressure vessel unit 10 can be used as a hydrogen tank unit, for example, and can be suitably mounted on a vehicle (a fuel cell electric vehicle, a hydrogen engine vehicle) of which fuel source is hydrogen.

As shown in FIG. 1, the pressure vessel unit 10 has four pressure vessels 2 (2a, 2b, 2c, 2d). Each of the pressure vessels 2a to 2d has the same shape. A joining portion 4 is fixed to one end side and end caps 8 are fixed to the other end side in the longitudinal direction. A main body part of the pressure vessel 2 is configured by a reinforcement portion 3 and a liner 5. The joining portion 4 connects the pressure vessels 2a to 2d. As one example, the material of the liner 5 is resin having a gas barrier property, the material of the reinforcement portion 3 is carbon fiber reinforced resin, and the material of the joining portion 4 and the end caps 8 is aluminum. A valve mounting hole 6 is provided in the joining portion 4. The valve mounting hole 6 is provided in a central part of the joining portion 4 in the direction in which the pressure vessels 2 line up (the direction orthogonal to the longitudinal direction of the pressure vessels 2). Although details are described later, a fluid flow passage 24 through which fluid passes when the fluid is supplied to each of the pressure vessels 2a to 2d is provided in the joining portion 4. The fluid flow passage 24 can be understood to be a manifold.

FIG. 2 shows a view in which an intermediate part of the pressure vessel 2 in the longitudinal direction is omitted. As shown in FIG. 2, both ends of the pressure vessel 2 in the longitudinal direction thereof are open, one end side of the opening is sealed with a first end plug 14, and the other end side is sealed with a second end plug 34. A fluid supply passage 16 for supplying fluid to a space 50 in the pressure vessel 2 is provided in the first end plug 14. The fluid supply passage 16 communicates with the fluid flow passage 24.

The first end plug 14 is fixed to one end side of the pressure vessel 2 by the joining portion 4. In other words, when the pressure vessels 2a to 2d are connected to the joining portion 4, the first end plugs 14 are fixed to all of the pressure vessels 2a to 2d (also see FIG. 1). Specifically, the first end plug 14 is fixed to the pressure vessel 2 by being sandwiched between a one-end-side end surface of the pressure vessel 2 in the longitudinal direction thereof and the joining portion 4.

A ferrule 12 for mounting the joining portion 4 onto the pressure vessel 2 is fastened to an outer peripheral surface of the pressure vessel 2. By fixing the joining portion 4 to the ferrule 12, the joining portion 4 is fixed to the pressure vessel 2. An O-ring 20 is disposed on an outer peripheral surface of the first end plug 14. The O-ring 20 is disposed in a ring groove provided in the outer peripheral surface of the first end plug 14. A backup ring 22 for restricting the movement of the O-ring 20 is also disposed in the ring groove. The O-ring 20 seals a place between the outer peripheral surface of the first end plug 14 and an inner peripheral surface of the liner 5. As a result, one end side of the pressure vessel 2 is sealed.

The fluid supply passage 16 for supplying fluid to the space 50 in the pressure vessel 2 is provided in the first end plug 14. The fluid supply passage 16 communicates with the fluid flow passage 24. The fluid supply passage 16 also functions as a flow passage of fluid (for example, hydrogen gas) accumulated in the pressure vessel 2 when the fluid is supplied to a fluid consumption source (for example, a fuel battery, a hydrogen engine).

The second end plug 34 is fixed to the pressure vessel 2 by the end cap 8. Specifically, the second end plug 34 is fixed to the pressure vessel 2 by being sandwiched between an other-end-side end surface of the pressure vessel 2 in the longitudinal direction thereof and the end cap 8.

A ferrule 32 for mounting the end cap 8 onto the pressure vessel 2 is fastened to the outer peripheral surface of the pressure vessel 2. By fixing the end cap 8 to the ferrule 32, the end cap 8 is fixed to the pressure vessel 2. An O-ring 40 is disposed on an outer peripheral surface of the second end plug 34. The O-ring 40 is disposed in a ring groove provided in the outer peripheral surface of the second end plug 34, and a backup ring 42 for restricting the movement of the O-ring 40 is also disposed in the ring groove. The O-ring 40 seals a place between the outer peripheral surface of the second end plug 34 and the inner peripheral surface of the liner 5. As a result, the other end side of the pressure vessel 2 is sealed.

A fluid discharge passage 38 for discharging fluid from the space 50 in the pressure vessel 2 is provided in the second end plug 34. A bolt 36 is fixed (fastened) to the second end plug 34 so as to close the fluid discharge passage 38. The bolt 36 is fixed to the second end plug 34 through an opening provided in the end cap 8. In a state in which the bolt 36 is fixed to the second end plug 34, a head portion of the bolt 36 is positioned on the inner side relative to an outer side surface of the second end plug 34. The bolt 36 is mountable and removable to and from the second end plug 34. At the time of a pressure-proof test of the pressure vessel unit 10 described below, the second end plug 34 is removed through the opening in the end cap 8 as needed.

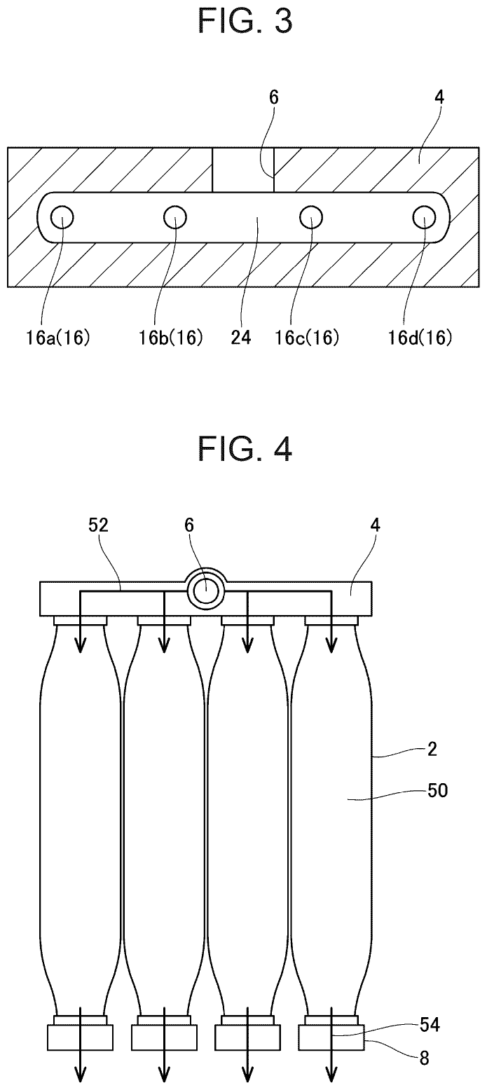

FIG. 3 shows a section of the joining portion 4. As shown in FIG. 3, a fluid flow passage 24 that communicates with fluid supply passages 16a to 16d of the pressure vessels 2a to 2d is provided on the inner side of the joining portion 4. The valve mounting hole 6 communicates with the fluid flow passage 24. An electromagnetic valve (not shown) for adjusting the flow rate of the fluid supplied to the fluid flow passage 24 is mounted in the valve mounting hole 6. When the fluid is to be supplied to the pressure vessels 2a to 2d, the fluid is supplied to the fluid flow passage 24 through the electromagnetic valve mounted in the valve mounting hole 6, and the fluid is supplied into the pressure vessels 2a to 2d through the fluid supply passages 16a to 16d.

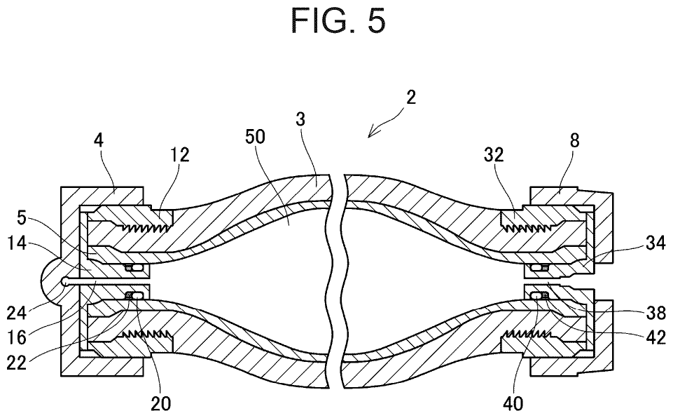

With reference to FIG. 4 and FIG. 5, an overview of the pressure-proof test is described. In the pressure-proof test, a predetermined valve is mounted in the valve mounting hole 6, the spaces 50 of the pressure vessels 2 (2a to 2d) are filled with a test fluid (non-corrosive fluid) as indicated by arrows 52, and pressure is applied until the pressure of the spaces 50 becomes 1.5 times or more of a nominal operating pressure (see FIG. 4). Then, the state in which the pressure that is 1.5 times or more is applied is maintained for 30 seconds or more, and it is confirmed that there is no leakage of the test fluid from the pressure vessels 2 nor abnormal expansion of the pressure vessels 2a to 2d and that the permanent increase rate of the pressure vessels 2 satisfies a defined value. The state in which the pressure is applied to the pressure vessels 2 is maintained in a state in which the bolts 36 are fixed to the second end plugs 34 (see FIG. 2).

As shown in FIG. 5, after the pressure-proof test ends, the bolts 36 are removed from the second end plugs 34, and communication is provided between the spaces 50 in the pressure vessels 2 and the external space. Then, as shown in FIG. 4, air is introduced into the spaces 50 in the pressure vessels 2 from the valve mounting hole 6 (arrows 52), and the test fluid is discharged from the fluid discharge passages 38 (arrows 54). The test fluid is discharged in a state in which the joining portion 4 is positioned on the upper side in the gravity direction and the end cap 8 is positioned on the lower side in the gravity direction. Then, while a state in which the bolts 36 are removed from the second end plugs 34 is maintained, dry air is introduced into the spaces 50 in the pressure vessels 2 from the valve mounting hole 6 (arrows 52), and the spaces 50 in the pressure vessels 2 are dried.

After the inside of the pressure vessels 2 is dried, the bolts 36 are fixed to the second end plugs 34 (from FIG. 5 to FIG. 2). When the end caps 8 are fixed, the pressure vessel unit 10 is completed. As above, in the pressure vessel unit 10, by simply mounting and removing the bolts 36 to and from the second end plugs 34, the pressure-proof test can be performed, and the discharge of the test fluid, the drying of the inside of the pressure vessels 2, and the reassembling of the pressure vessel unit 10 after the pressure-proof test can be performed. In other words, in the pressure vessel unit 10, it is possible to substantially perform the pressure-proof test while maintaining the state of the pressure vessel unit 10.

Even when a related-art pressure vessel unit is used, the process up to filling the pressure vessels with the test fluid can be performed as with that for the pressure vessel unit 10. However, in the case of the related-art pressure vessel unit, a joining portion, an end cap, a first end plug, a second end plug, backup rings (two places), and O-rings (two places) need to be removed in order to discharge the test fluid from the inside of each pressure vessel and dry the inside of the pressure vessel, and then the pressure vessel unit needs to be assembled again. The backup rings and the O-rings used in the pressure-proof test cannot be reused. Therefore, new backup rings and new O-rings need to be mounted on the pressure vessel after the pressure-proof test. As described above, regarding the pressure vessel unit 10, the pressure-proof test can be performed by simply mounting and removing the bolts 36 to and from the second end plugs 34 in a state of a final product. Therefore, as compared to the related-art pressure vessel unit, the process necessary for mounting and removing parts can be simplified and the number of parts can be omitted in the pressure vessel unit 10.

In the related-art pressure vessel unit, there are cases in which the pressure-proof test is performed in each single pressure vessel, and the pressure vessel unit is assembled after the pressure-proof test ends. The end cap, the first end plug, the second end plug, the backup rings (two places), and the O-rings (two places) need to be removed in order to discharge the test fluid from the inside of each pressure vessel and dry the inside of the pressure vessel, and the pressure vessel unit needs to be assembled again with use of new backup rings and new O-rings in this case as well. An airtight test of the pressure vessel unit also needs to be performed after the pressure vessels are connected to the joining portion. Therefore, the process necessary for mounting and removing parts can be simplified and the number of parts can be omitted in the pressure vessel unit 10 as compared to the related-art pressure vessel unit in which the pressure-proof test is performed in each single pressure vessel and the pressure vessel unit is assembled after the pressure-proof test ends.

In the pressure vessel unit 10, each bolt 36 can be mounted and removed to and from the second end plug 34 at a torque of 10 N·m or less, for example. Therefore, the bolt 36 can be easily mounted and removed to and from the second end plug 34 with use of a general-purpose tool. Meanwhile, in order to mount and remove the end cap 8 to and from the pressure vessel 2, a torque of 200 N·m or more is necessary, for example. As described above, in the related-art pressure vessel unit, the end cap needs to be mounted and removed in order to discharge the test fluid from the inside of the pressure vessel and dry the inside of the pressure vessel. Regarding the pressure vessel unit 10, a fastening operation after the pressure-proof test can also be facilitated.

In the embodiment described above, the pressure vessel unit including four pressure vessels has been described. However, the technology disclosed in the present specification can also be applied to a pressure vessel unit including three or less or five or more pressure vessels. In the related-art pressure vessel unit, as the number of pressure vessels included in the pressure vessel unit increases, the amount of time necessary for mounting and removing the parts at the time of the pressure-proof test, and the number of parts that is used increases. Therefore, with the technology disclosed in the present specification, it is possible to obtain advantages that are more significant in the pressure vessel unit in which the number of pressure vessels is large.

The embodiment of the present disclosure has been described in detail above, but the above is merely an exemplification and does not limit the scope of claims. The technology described in the scope of claims includes those obtained by variously modifying and changing the specific examples exemplified above. The technical elements described in the present specification or the drawings exhibit a technical utility by itself or by various combinations, and are not limited to the combinations described in the claims as originally filed. The technology exemplified in the present specification or the drawings achieve a plurality of objects at the same time, and has a technical utility by achievement of one of those objects itself.

What is claimed is:

1. A pressure vessel unit, comprising:
a plurality of pressure vessels each having both ends in a longitudinal direction that are open;
first end plugs each provided in a corresponding one of the pressure vessels, the first end plugs each being configured to seal an opening on one end side in the longitudinal direction, the first end plugs each being provided with a fluid supply passage through which fluid is to be supplied to the pressure vessel;
second end plugs each provided in a corresponding one of the pressure vessels, the second end plugs each being configured to seal an opening on another end side in the longitudinal direction, the second end plugs each being provided with a fluid discharge passage through which the fluid is to be discharged from the pressure vessel;
a joining portion configured to connect the pressure vessels; and
bolts that are each fixed to a corresponding one of the second end plugs in a mountable and removable manner, the bolts each being configured to close the fluid discharge passage.

2. The pressure vessel unit according to claim 1, wherein the joining portion has a fluid flow passage joined to all of the fluid supply passages, and a valve mounting hole for mounting a valve configured to perform supply control of the fluid to the fluid flow passages.

3. The pressure vessel unit according to claim 2, wherein the joining portion is configured to fix the first end plug to the one end side when the pressure vessel is connected.

4. The pressure vessel unit according to claim 1, wherein an end cap for fixing the second end plug to the other end side is fixed to the other end side of the pressure vessel.

5. The pressure vessel unit according to claim 4, wherein an opening through which the bolt passes when the bolt is mounted or removed is provided in the end cap.
